(19) United States
(12) Patent Application Publication
(10) Pub. No.: US 2015/0379537 A1
(43) Pub. Date: Dec. 31, 2015

(54) METHOD AND SYSTEM FOR GENERATING GEOGRAPHIC POLYGONS USING PURCHASE DATA

(71) Applicant: MasterCard International Incorporated, Purchase, NY (US)

(72) Inventor: Debashis GHOSH, Charlotte, NC (US)

(73) Assignee: MASTERCARD INTERNATIONAL INCORPORATED, Purchase, NY (US)

(21) Appl. No.: 14/317,456

(22) Filed: Jun. 27, 2014

(51) Int. Cl. G06Q 30/02; G06F 17/30

(52) U.S. Cl. CPC G06Q 30/0205; G06F 17/30241; G06F 17/30554

(57) ABSTRACT

A method for generating a consumer polygon map includes: storing a plurality of consumer profiles, wherein each consumer profile includes data related to a consumer including a consumer identifier and a plurality of transaction data entries, each transaction data entry including data related to a payment transaction involving the related consumer including transaction data and a geographic location; receiving a request for a consumer polygon, wherein the request for a consumer polygon includes a specific consumer identifier; identifying a specific consumer profile where the included consumer identifier corresponds to the specific consumer identifier; and generating a polygon map for the consumer related to the specific consumer profile, wherein the polygon map includes a plurality of polygon vertices, each polygon vertex being at a geographic location corresponding to a geographic location included in a transaction data entry included in the specific consumer profile.

### FIELD

The present disclosure relates to the generating of consumer polygon maps, specifically the generating of a polygon representing consumer purchase behavior where vertices of the polygon are geographic locations of payment transactions involving the consumer.

### BACKGROUND

Merchants, manufacturers, content providers, and other entities are often interested in data regarding consumers' movements and behavior. Knowing where consumers are located at a specific time or where they are predicted to be at a later time can be valuable for entities. Such information can help a merchants advertise to consumers, such as a merchant offering a consumer a discount to entice them into a store when they are nearby, or a merchant targeting consumers that regularly visit their trade area in an advertising campaign.

Current methods for identifying consumer locations and movement include monitoring geographic locations of a mobile device associated with a consumer. However, mobile device locations may be unreliable or inaccurate, and, in some cases, mobile devices may have a dead battery or be out of service and unable to report their location. Furthermore, locations of a consumer using their mobile device may not be indicative of transactions conducted by the consumer, and thus may not be as valuable to merchants and other entities.

One method for identifying consumer locations includes identifying a centroid for a consumer based on their purchase behavior, such as described in U.S. patent application Ser. No. 13/721,216, entitled “Method and System for Assigning Spending Behaviors to Geographic Areas,” filed on Dec. 20, 2012, by Curtis Villars, which is herein incorporated by reference in its entirety. However, centroids may not provide detail regarding time or patterns of movement. In addition, centroids may be used to select an area for a consumer, but such an area may thereby include significant areas where the consumer does not regularly transact, or may fail to extend to locations where the consumer does regularly transaction.

Thus, there is a need for a technical solution to identify a map regarding a consumer's purchasing behavior that identifies known geographic locations where the consumer transacts, as well as timing and/or movement of the consumer between the geographic locations.

### SUMMARY

The present disclosure provides a description of systems and methods for generating a consumer polygon map.

A method for generating a consumer polygon map includes: storing, in a profile database, a plurality of consumer profiles, wherein each consumer profile includes data related to a consumer including at least a consumer identifier and a plurality of transaction data entries, each transaction data entry including data related to a payment transaction involving the related consumer including at least transaction data and a geographic location; receiving, by a receiving device, a request for a consumer polygon, wherein the request for a consumer polygon includes at least a specific consumer identifier; identifying, in the profile database, a specific consumer profile where the included consumer identifier corresponds to the specific consumer identifier; and generating, by a processing device, a polygon map for the consumer related to the specific consumer profile, wherein the polygon map includes a plurality of polygon vertices, each polygon vertex being at a geographic location corresponding to a geographic location included in a transaction data entry included in the specific consumer profile.

A system for generating a consumer polygon map includes a profile database, a receiving device, and a processing device. The profile database is configured to store a plurality of consumer profiles, wherein each consumer profile includes data related to a consumer including at least a consumer identifier and a plurality of transaction data entries, each transaction data entry including data related to a payment transaction involving the related consumer including at least transaction data and a geographic location. The receiving device is configured to receive a request for a consumer polygon, wherein the request for a consumer polygon includes at least a specific consumer identifier. The processing device is configured to: identify, in the profile database, a specific consumer profile where the included consumer identifier corresponds to the specific consumer identifier; and generate a polygon map for the consumer related to the specific consumer profile, wherein the polygon map includes a plurality of polygon vertices, each polygon vertex being at a geographic location corresponding to a geographic location included in a transaction data entry included in the specific consumer profile.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a high level architecture illustrating a system for generating consumer polygon maps in accordance with exemplary embodiments.

FIG. 2 is a block diagram illustrating the processing server of FIG. 1 for the generation of consumer polygon maps in accordance with exemplary embodiments.

FIG. 3 is a flow diagram illustrating a process for generating a polygon map for a requested consumer based on purchase data in accordance with exemplary embodiments.

FIG. 4 is a flow diagram illustrating a process for generating polygon maps and identification thereof of maps corresponding to requested criteria in accordance with exemplary embodiments.

FIG. 5 is an illustrating of an exemplary polygon map generated based on consumer purchase data in accordance with exemplary embodiments.

FIG. 6 is a flow chart illustrating an exemplary method for generating a consumer polygon map in accordance with exemplary embodiments.

FIG. 7 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by MasterCard®, VISA®, Discover®, American Express®, etc.

### System for Generating Consumer Polygon Maps

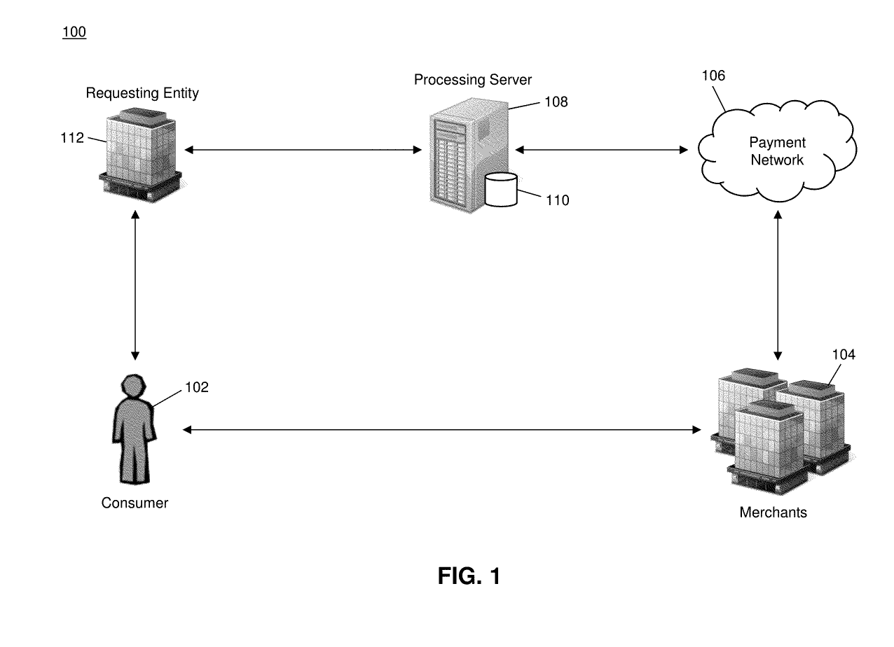

FIG. 1 illustrates a system 100 for the generation of consumer polygon maps based on consumer purchase data.

The system 100 may include a consumer 102. The consumer 102 may conduct a plurality of payment transactions with one or more merchants 104. The payment transactions involving the consumer 102 and merchants 104 may be processed by a payment network 106. As part of the processing of the transactions, the payment network 106 may provide transaction data for the payment transactions to a processing server 108. The processing server 108, discussed in more detail below, may be configured to generate a polygon map for the consumer 102 based on the received transaction data for the payment transactions involving the consumer 102. In some embodiments, the processing server 108 may be a part of the payment network 106.

The processing server 108 may receive the transaction data from the payment network 106 and store it in a profile database 110 in a consumer profile associated with the consumer 102. The transaction data may include data for a plurality of payment transactions involving the consumer 102 including transaction data, such as a transaction amount, product data, etc. and a geographic location for each respective payment transaction.

The processing server 108 may then generate a polygon map for the consumer 102 based on the information stored in the consumer profile in the profile database 110. The consumer polygon map may include a plurality of vertices, with each vertex being at a geographic location of a payment transaction involving the consumer 102. In some instances, the polygon map may be generated such that lines connecting the vertices of the polygon are drawn to connection vertices that are temporally adjacent to one another. That is to say, the polygon map may include a vertex at each geographic location for a set of transactions conducted in a single day, with the lines connecting vertices in the order that the transactions were conducted in that day.

The processing server 108 may also be configured to generate a plurality of polygon maps for the consumer 102. In such an instance, the processing server 108 may create a polygon map based on one or more criteria, such as a polygon map for transactions conducted during the week, for transactions conducted on weekends, for transactions conducted on a particular day or range of days, transactions conducted on days with specified weather conditions, on transactions conducted for specific merchant or product categories, transactions conducted in a specified geographic area, etc. Additional types of polygon maps will be apparent to persons having skill in the relevant art.

In some embodiments, the system 100 may include a requesting entity 112. The requesting entity 112 may be a merchant, advertiser, manufacturer, content provider, offer provider, or other entity that may request one or more consumer polygon maps from the processing server 108. In some embodiments, the requesting entity 112 may identify a specific consumer 102 for which a map is requested. In such an embodiment, the processing server 108 may identify the consumer profile for the specific consumer 102 and may generate the polygon map. In some instances, the requesting entity 112 may request a specific type of polygon map, such as a polygon map of restaurants visited by the identified consumer 102 during the week.

In some embodiments, the requesting entity 112 may provide specific criteria to the processing server 108 for which consumer polygon maps are requested. For example, the requesting entity 112 may request polygon maps for consumers' shopping at clothing stores on weekends. The processing server 108 may then identify polygon maps that correspond to the requesting entity's 112 request, and may furnish them to the requesting entity 112. In another embodiment, the requesting entity 112 may specify a geographic location, and the processing server 108 may identify polygon maps for consumers 102 that include or encompass that geographic location. In some instances, the processing server 108 may provide demographic information for the consumers whose polygon maps encompass the geographic location, such as may be stored in the corresponding consumer profiles.

The generation of consumer polygon maps by the processing server 108 may provide for more accurate and valuable data regarding the movements and purchases of consumers 102. Polygon maps may have more accurate area representations of a consumer's 102 regular transacting area, and may more efficiently and effectively convey the consumer's 102 purchase behavior in terms of movement and time. As a result, the polygon maps generated by the processing server 108 using the methods and systems discussed herein may be more beneficial to requesting entities 112, merchants 104, and/or other entities than existing methods for identifying consumer locations and trade areas.

### Processing Server

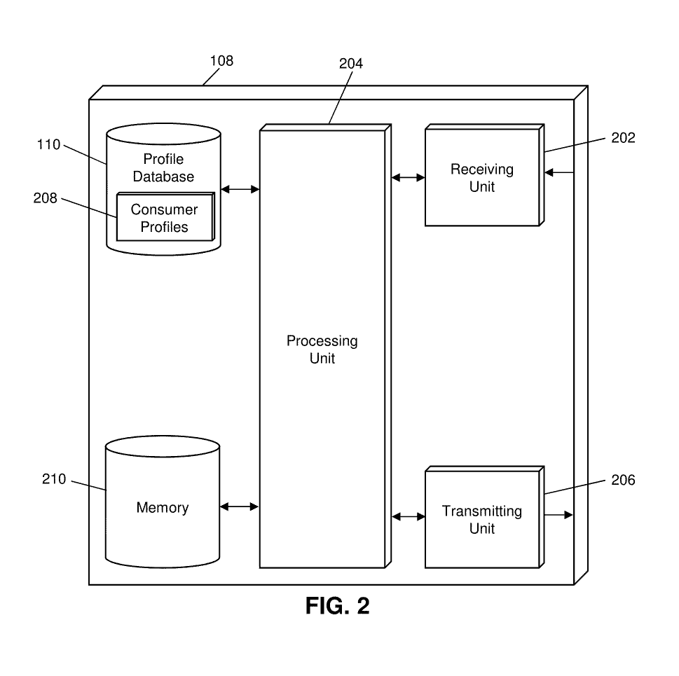

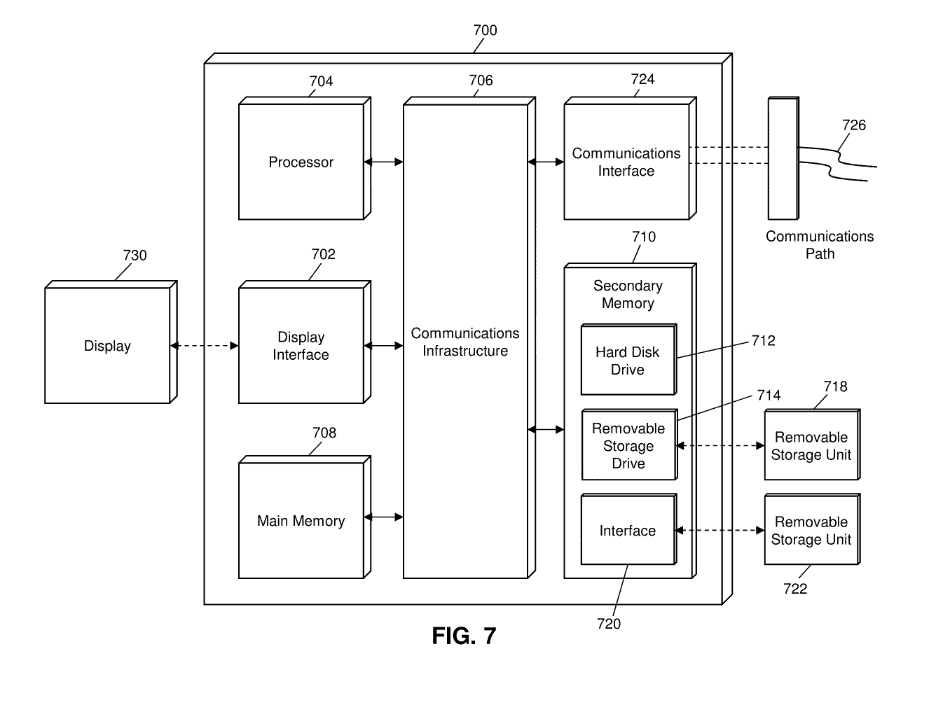

FIG. 2 illustrates an embodiment of the processing server 108 of the system 100. It will be apparent to persons having skill in the relevant art that the embodiment of the processing server 108 illustrated in FIG. 2 is provided as illustration only and may not be exhaustive to all possible configurations of the processing server 108 suitable for performing the functions as discussed herein. For example, the computer system 700 illustrated in FIG. 7 and discussed in more detail below may be a suitable configuration of the processing server 108.

The processing server 108 may include a receiving unit 202. The receiving unit 202 may be configured to receive data over one or more networks via one or more network protocols. The receiving unit 202 may receive transaction data from the payment network 108. The processing server 108 may also include the profile database 110. The received transaction data may be stored in the profile database 110 in one or more consumer profiles 208. Each consumer profile 208 may include data related to a consumer 102 including at least a consumer identifier and a plurality of transaction data entries.

The consumer identifier may be a unique value suitable for identifying the related consumer 102 and/or the respective consumer profile 208. The consumer identifier may be an identification number, payment account number, username, e-mail address, telephone number, street address, or other suitable value as will be apparent to persons having skill in the relevant art. Each of the plurality of transaction data entries may include data received in the received transaction data and may be related to a payment transaction involving the related consumer 102.

Each transaction data entry may include at least transaction data and a geographic location associated with the related payment transaction. The geographic location may be represented as latitude and longitude, geographic coordinates, a street address, an identification number, a point of sale identifier, or any other suitable representation of a geographic location. The transaction data may include a transaction amount, merchant category, product category, transaction time and/or date, product data, merchant data, or any other data suitable for use in performing the functions disclosed herein.

The processing server 108 may further include a processing unit 204. The processing unit 204 may be configured to perform the functions of the processing server 108 disclosed herein, such as the storage of received transaction data in the respective consumer profiles 208. The processing unit 204 may also be configured to generate consumer polygon maps based on stored transaction data. A polygon map may be generated for a set of transaction data entries included in a consumer profile 208 stored in the profile database 110. The set of transaction data entries may be identified by the processing unit 204 based on the polygon map to be generated. For instance, if a consumer polygon map is to be generated for a consumer's 102 transactions on weekends, the processing unit 204 may first identify transaction data entries whose transaction data includes a transaction time and/or date indicating that the related payment transaction was conducted on a weekend.

The processing unit 204 may be configured to generate polygon maps whose vertices are at geographic locations that correspond to geographic locations of transaction data entries included in the identified set of transaction data entries. In some embodiments, the vertices may be connected with lines based on their location. For instance, lines may be drawn from one vertex to the next two closest vertices in such a way as to create a map without any enclosed vertices. In other embodiments, lines may be connected based on the times of the corresponding payment transactions, such as connecting lines from the vertex of one transaction to the vertex of the next transaction conducted by the related consumer 102.

In some instances, the processing unit 204 may be configured to filter out geographic locations when creating a polygon map. For example, the processing unit 204 may filter out outlying geographic locations, such as geographic locations that are a considerable distance from other geographic locations. For instance, such locations may represent one-time transactions or transactions conducted on a vacation of the consumer 102, and may thereby not be representative of the consumer's 102 regular conducting of transactions. In some embodiments, the processing unit 204 may identify vertices for a consumer polygon map based on average geographic locations of subsets of transaction data entries. For example, a single vertex may be identified to represent a group of transactions that occur within a short distance from one another, a single vertex being used to represent every transaction conducted in a shopping mall. Additional criteria for filtering and/or representing transactions and/or vertices will be apparent to persons having skill in the relevant art.

In some embodiments, the receiving unit 202 may be configured to receive a request for a consumer polygon map. In such an embodiment, the request may be submitted by the requesting entity 112, the consumer 102, a merchant 104, or any other suitable entity, such as via a request submitted over a network. In some instances, the request may be received via an input device configured to communicate with the processing server 108, such as a keyboard, mouse, microphone, camera, touch screen, etc. For example, the processing server 108 may be a computing device with a user interface, which a user may interact with to request (e.g., and view, via the interface) a consumer polygon map. The processing unit 204 may be configured to generate a polygon map based on the received request.

The processing server 108 may also include a transmitting unit 206. The transmitting unit 206 may be configured to transmit data over one or more networks via one or more network protocols. The transmitting unit 206 may be configured to transmit generated consumer polygon maps to the requesting entity 112 or other suitable entity in response to a received request for a polygon map. In some instances, the transmitting unit 206 may be configured to transmit consumer data to a requesting entity 112 based on a request received by the receiving unit 202, such as consumer data associated with consumer 102 whose polygon maps fit specified criteria.

The processing server 108 may further include a memory 210. The memory 210 may be configured to store data suitable for performing the functions disclosed here that will be apparent to persons having skill in the relevant art. For example, the memory 210 may store geographic data, such as maps and coordinate data used for the mapping of the consumer polygon, algorithms for the drawing of lines and/or vertices in a polygon map, rules or algorithms for filtering transactions for generating a polygon map, etc.

### Process for Generating a Consumer Polygon Map

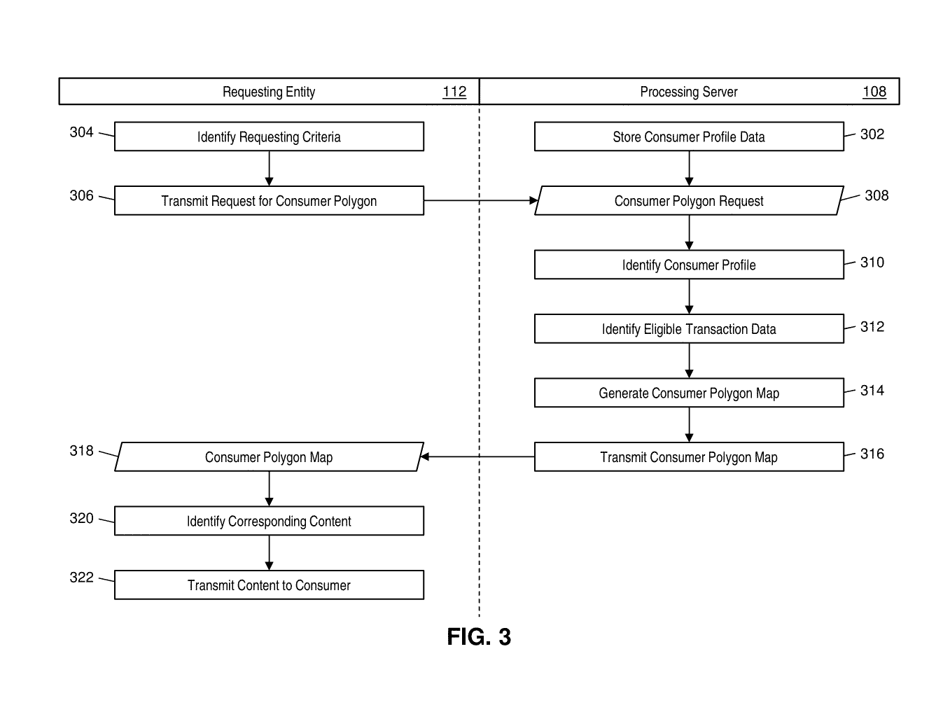

FIG. 3 illustrates a process for the generating of a consumer polygon map based on consumer purchase data in response to a request received from a requesting entity 112.

In step 302, the processing unit 204 of the processing server 108 may store consumer profile data as a plurality of consumer profiles 208 in the profile database 110. Each consumer profile 208 may include a plurality of transaction data entries related to payment transactions involving a related consumer, including at least a geographic location for each payment transaction.

In step 304, the requesting entity 112 may identify requesting criteria for a consumer polygon or polygons that may be desired. For instance, the requesting entity 112 may identify the type of consumer polygon maps desired, such as for weekend transactions, for transactions in a specific geographic area, and/or for transactions in a specific industry. In another instance, the request entity 112 may identify multiple consumers 102 for which consumer polygons are desired, such as by identifying specific consumers 102 or by identifying criteria suitable for the selection of consumers 102 (e.g., demographic characteristics).

In step 306, a request for a consumer polygon may be transmitted from the requesting entity 112 to the processing server 108. In step 308, the receiving unit 202 of the processing server 108 may receive the consumer polygon request, which may include the requesting criteria and may identify one or more consumers 102 for which a consumer polygon is requested. In step 310, the processing unit 204 may identify the consumer profile or profiles 208 corresponding to consumers 102 for which polygon maps are requested. In step 312, the processing unit 204 will identify transaction data entries in the identified consumer profile 208 that are to be used to generate the map, based on the requesting criteria included in the received consumer polygon request.

In step 314, the processing unit 204 may generate the consumer polygon map for the identified consumer profile 208 or profiles 208 using the transaction data entries identified in step 312. The consumer polygon map may be a polygon with vertices located at geographic locations that correspond to geographic locations included in the identified transaction data entries. In some embodiments, the vertices may be connected with lines based on the timing of the related payment transactions or other criteria, such as identified in the consumer polygon request. For instance, the requesting entity 112 may request lines be drawn based on time, location, or other transaction data, such as transaction amount, frequency, etc.

In step 316, the transmitting unit 206 of the processing server 108 may transmit the generated consumer polygon map to the requesting entity 112 in response to the earlier received request for a consumer polygon. In step 318, the requesting entity 112 may receive the consumer polygon map. In step 320, the requesting entity 112 may identify content to be distributed to the consumer 102 associated with the consumer polygon map, such as advertising content that may be based on the consumer polygon. In step 322, the identified content may be transmitted to the consumer 102.

### Process for Identifying Consumer Profiles Based on Polygon Maps

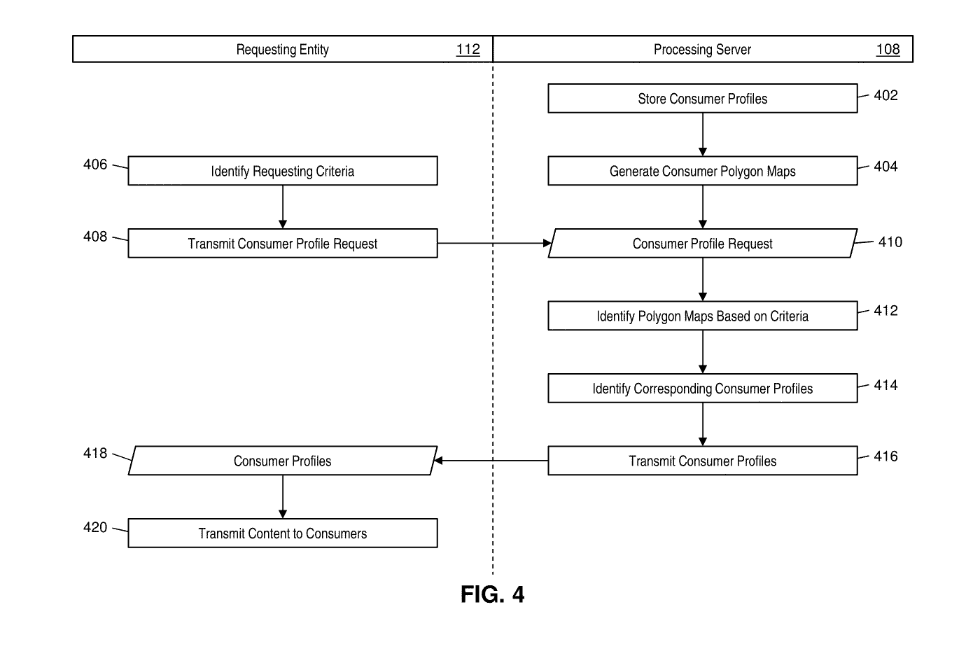

FIG. 4 illustrates a process for the identification of previously-generated consumer polygon maps based on supplied criteria for the identification of corresponding consumer profiles.

In step 402, the processing server 108 may store a plurality of consumer profiles 208 in the profile database 110. Each consumer profile 208 may include at least a plurality of transaction data entries, each related to a payment transaction involving the related consumer 102 and including at least transaction data and a geographic location associated with the related payment transaction. In step 404, the processing unit 204 of the processing server 108 may generate consumer polygon maps for each consumer profile 208 stored in the profile database 110. The generated consumer polygon maps may be based on the geographic locations and/or transaction data included in each transaction data entry included in the respective consumer profile 208.

In some embodiments, the processing unit 204 may generate a plurality of consumer polygon maps for each consumer profile 208. For example, the processing unit 204 may generate a consumer polygon map based on transaction data entries for each of a plurality of criteria, such as time criteria (e.g., weekend, weekday, time of month, season, etc.), transaction criteria (e.g., specific industry or industries, specific merchant or merchants, geographic areas, transaction amounts, etc.), and additional criteria that will be apparent to persons having skill in the relevant art.

In step 406, the requesting entity 112 may identify requesting criteria, which may be criteria for which consumer profiles are to be requested. For instance, the requesting entity 112 may be interested in consumers that regularly transact in a specific geographic area on the weekends. In step 408, the requesting entity 112 may transmit a request for consumer profiles to the processing server 108. In step 410, the receiving unit 202 of the processing server 108 may receive the request for consumer profiles. The request may include at least the requesting criteria previously identified by the requesting entity 112.

In step 412, the processing unit 204 may identify consumer polygon maps based on the criteria included in the request for consumer profiles. For instance, in the example of the requesting entity 112 requesting consumer profiles for consumers that regularly transaction in a specific geographic area on the weekends, the processing unit 204 may analyze consumer polygon maps that correspond to weekend transactions for each consumer profile 208 and may identify those polygon maps where the polygon encompasses and/or includes the specific geographic area. Once the polygon maps have been identified, then, in step 414, the processing unit 204 may identify the corresponding consumer profiles 208.

In step 416, the processing server 108 may transmit the identified consumer profiles 208, and/or consumer data included therein, to the requesting entity 112. The consumer data transmitted to the requesting entity 112 may include contact information (e.g., with the consent of the related consumer 102), demographic information, purchase behavior, spending behavior, or other suitable data as will be apparent to persons having skill in the relevant art. In step 418, the requesting entity 112 may receive the consumer profiles 208. In step 420, the requesting entity 112 may transmit content to the consumers 102 related to the received consumer profiles 208. For instance, the requesting entity 112 may be a merchant 104 located in the specific geographic area, and may distributed advertisements or coupons to the consumers 102 related to the received consumer profiles 208.

### Consumer Polygon Map

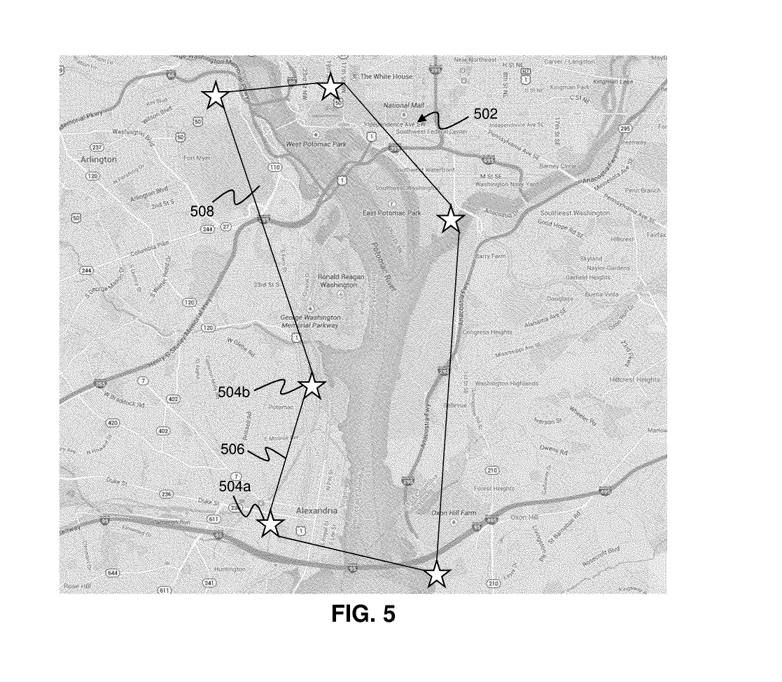

FIG. 5 is an illustration of an exemplary consumer polygon map. It will be apparent to persons having skill in the relevant art that the consumer polygon map illustrated in FIG. 5 and discussed herein is an illustration only, and that other configurations and implementations of a consumer polygon map using the methods and systems discussed herein may be used and/or generated.

Using the methods and systems discussed herein, the processing unit 204 of the processing server 108 may generate a consumer polygon map 502 for a consumer 102 based on transaction data for payment transactions involving the consumer 102, including geographic location data. The consumer polygon map 502 may include a plurality of vertices 504. Each vertex 504 may correspond to one or more transaction data entries and may be located at a geographic location associated with the corresponding one or more transaction data entries.

Each vertex 504 may be connected with two other vertices 504 via a line 506. Each line 506 may connect two of the vertices 504 in order to form a polygon area 508. In some embodiments, the vertices 504 connected via a line 506 may be based on time or other factors. For example, in the polygon map 502 illustrated in FIG. 5, the vertex 504a may be located at the geographic location of a first payment transaction, and the vertex 504b may be located at the geographic location of the next payment transaction conducted by the related consumer 102 on a specific day.

The polygon area 508 formed from the lines 506 and vertices 504 may correspond to a geographic area covered by the consumer 102 during the course of their conducted payment transactions. In some instances, the polygon area 508 may be different for the same set of transaction data entries, and in some cases the same vertices 504, such as by different drawing of the lines 506. For example, if the lines 506 were drawn based on time in one polygon map 502, but based on distance in another polygon map 502, the polygon areas 508 in each polygon map 502 may be different.

### Exemplary Method for Generating a Consumer Polygon Map

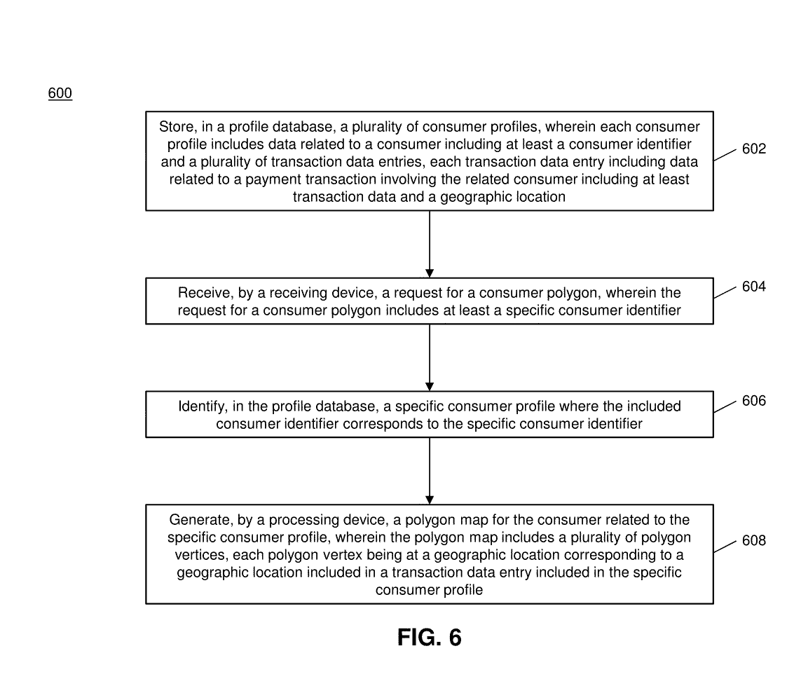

FIG. 6 illustrates a method 600 for the generation of a consumer polygon map based on consumer purchase data.

In step 602, a plurality of consumer profiles (e.g., consumer profiles 208) may be stored in a profile database (e.g., the profile database 110), wherein each consumer profile 208 includes data related to a consumer (e.g., the consumer 102) including at least a consumer identifier and a plurality of transaction data entries, each transaction data entry including data related to a payment transaction involving the related consumer 102 and including at least transaction data and a geographic location. In step 604, a request for a consumer polygon may be received by a receiving device (e.g., the receiving unit 202), wherein the request for a consumer polygon includes at least a specific consumer identifier.

In step 606, a specific consumer profile 208 may be identified in the profile database 110 where the included consumer identifier corresponds to the specific consumer identifier. In step 606, a polygon map (e.g., the polygon map 502) may be generated, by a processing device (e.g., the processing unit 204), for the consumer 102 related to the specific consumer profile 208, wherein the polygon map 502 includes a plurality of polygon vertices (e.g., the vertices 504), each polygon vertex 504 being at a geographic location corresponding to a geographic location included in a transaction data entry included in the specific consumer profile 208.

In one embodiment, each polygon vertex 504 included in the generated polygon map 502 may be within a predetermined geographic distance from each other polygon vertex 504. In some embodiments, each transaction data entry may further include a transaction time and/or date, and each polygon vertex 504 included in the generated polygon map 502 may be associated with the transaction time and/or date included in the corresponding transaction data entry included in the specific consumer profile 208. In a further embodiment, the generated polygon map 502 may include a plurality of polygon sides (e.g., lines 506), each polygon side 506 connecting at least two polygon vertices 504, the two polygon vertices 504 including consecutive transaction times and/or dates.

In one embodiment, each transaction data entry may further include a transaction time and/or date, and each polygon vertex 504 included in the generated polygon map 502 may correspond to a transaction data entry included in the specific consumer profile 208 including a transaction time and/or date within a predetermined period of time. In some embodiments, the method 600 may further include transmitting, by a transmitting device (e.g., the transmitting unit 206), the generated polygon map 502. In one embodiment, the method 600 may further include analyzing, by the processing device 204, the geographic location included in each transaction data entry included in the specific consumer profile 208 to identify a plurality of frequent geographic locations associated with the related consumer 102, wherein the geographic location for each polygon vertex 504 is an identified frequent geographic location.

In some embodiments, the request for a consumer polygon may further include a specific transaction criteria, and the transaction data included in each transaction data entry corresponding to a polygon vertex 504 may include the specific transaction criteria. In a further embodiment, the request for a consumer polygon may further include one or more additional transaction criteria, and the method 600 may further include: generating, by the processing device 204, an additional polygon map 502 for the consumer 102 related to the specific consumer profile 208 for each of the one or more additional transaction criteria, wherein each of the one or more additional polygon maps 502 includes a plurality of polygon vertices 504, each polygon vertex 504 being at a geographic location included in a transaction data entry included in the specific consumer profile 208 where the included transaction data includes the respective additional transaction criteria. In another further embodiment, the specific transaction criteria may include at least one of: a time and/or date, one or more days of the weekend, one or more days of the month, one or more months, a weather condition, a merchant category, a product category, and one or more geographic locations.

In one embodiment, the method 600 may further include generating, by the processing device 204, a plurality of polygon maps for a plurality of consumers, and aggregating, by the processing device, sets of polygon maps based on at least one of: similarity of polygons, overlap of polygons, common demographics, and common transaction profiles.

### Computer System Architecture

FIG. 7 illustrates a computer system 700 in which embodiments of the present disclosure, or portions thereof, may be implemented as computer-readable code. For example, the processing server 108 of FIG. 1 may be implemented in the computer system 700 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3, 4, and 6.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 718, a removable storage unit 722, and a hard disk installed in hard disk drive 712.

Various embodiments of the present disclosure are described in terms of this example computer system 700. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 704 may be a special purpose or a general purpose processor device. The processor device 704 may be connected to a communications infrastructure 706, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 700 may also include a main memory 708 (e.g., random access memory, read-only memory, etc.), and may also include a secondary memory 710. The secondary memory 710 may include the hard disk drive 712 and a removable storage drive 714, such as a floppy disk drive, a magnetic tape drive, an optical disk drive, a flash memory, etc.

The removable storage drive 714 may read from and/or write to the removable storage unit 718 in a well-known manner. The removable storage unit 718 may include a removable storage media that may be read by and written to by the removable storage drive 714. For example, if the removable storage drive 714 is a floppy disk drive or universal serial bus port, the removable storage unit 718 may be a floppy disk or portable flash drive, respectively. In one embodiment, the removable storage unit 718 may be non-transitory computer readable recording media.

In some embodiments, the secondary memory 710 may include alternative means for allowing computer programs or other instructions to be loaded into the computer system 700, for example, the removable storage unit 722 and an interface 720. Examples of such means may include a program cartridge and cartridge interface (e.g., as found in video game systems), a removable memory chip (e.g., EEPROM, PROM, etc.) and associated socket, and other removable storage units 722 and interfaces 720 as will be apparent to persons having skill in the relevant art.

Data stored in the computer system 700 (e.g., in the main memory 708 and/or the secondary memory 710) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 700 may also include a communications interface 724. The communications interface 724 may be configured to allow software and data to be transferred between the computer system 700 and external devices. Exemplary communications interfaces 724 may include a modem, a network interface (e.g., an Ethernet card), a communications port, a PCMCIA slot and card, etc. Software and data transferred via the communications interface 724 may be in the form of signals, which may be electronic, electromagnetic, optical, or other signals as will be apparent to persons having skill in the relevant art. The signals may travel via a communications path 726, which may be configured to carry the signals and may be implemented using wire, cable, fiber optics, a phone line, a cellular phone link, a radio frequency link, etc.

The computer system 700 may further include a display interface 702. The display interface 702 may be configured to allow data to be transferred between the computer system 700 and external display 730. Exemplary display interfaces 702 may include high-definition multimedia interface (HDMI), digital visual interface (DVI), video graphics array (VGA), etc. The display 730 may be any suitable type of display for displaying data transmitted via the display interface 702 of the computer system 700, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 708 and secondary memory 710, which may be memory semiconductors (e.g., DRAMs, etc.). These computer program products may be means for providing software to the computer system 700. Computer programs (e.g., computer control logic) may be stored in the main memory 708 and/or the secondary memory 710. Computer programs may also be received via the communications interface 724. Such computer programs, when executed, may enable computer system 700 to implement the present methods as discussed herein. In particular, the computer programs, when executed, may enable processor device 704 to implement the methods illustrated by FIGS. 3, 4, and 6, as discussed herein. Accordingly, such computer programs may represent controllers of the computer system 700. Where the present disclosure is implemented using software, the software may be stored in a computer program product and loaded into the computer system 700 using the removable storage drive 714, interface 720, and hard disk drive 712, or communications interface 724.

Techniques consistent with the present disclosure provide, among other features, systems and methods for generating consumer polygon maps. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for generating a consumer polygon map, comprising:
storing, in a profile database, a plurality of consumer profiles, wherein each consumer profile includes data related to a consumer including at least a consumer identifier and a plurality of transaction data entries, each transaction data entry including data related to a payment transaction involving the related consumer including at least transaction data and a geographic location;
receiving, by a receiving device, a request for a consumer polygon, wherein the request for a consumer polygon includes at least a specific consumer identifier;
identifying, in the profile database, a specific consumer profile where the included consumer identifier corresponds to the specific consumer identifier; and
generating, by a processing device, a polygon map for the consumer related to the specific consumer profile, wherein the polygon map includes a plurality of polygon vertices, each polygon vertex being at a geographic location corresponding to a geographic location included in a transaction data entry included in the specific consumer profile.

2. The method of claim 1, wherein each polygon vertex included in the generated polygon map is within a predetermined geographic distance from each other polygon vertex.

3. The method of claim 1, wherein
each transaction data entry further includes a transaction time and/or date, and
each polygon vertex included in the generated polygon map is associated with the transaction time and/or date included in the corresponding transaction data entry included in the specific consumer profile.

4. The method of claim 3, wherein the generated polygon map includes a plurality of polygon sides, each polygon side connecting at least two polygon vertices, the two polygon vertices including consecutive transaction times and/or dates.

5. The method of claim 1, wherein
each transaction data entry further includes a transaction time and/or date, and
each polygon vertex included in the generated polygon map corresponds to a transaction data entry included in the specific consumer profile including a transaction time and/or date within a predetermined period of time.

6. The method of claim 1, further comprising:
transmitting, by a transmitting device, the generated polygon map.

7. The method of claim 1, further comprising:
analyzing, by the processing device, the geographic location included in each transaction data entry included in the specific consumer profile to identify a plurality of frequent geographic locations associated with the related consumer, wherein
the geographic location for each polygon vertex is an identified frequent geographic location.

8. The method of claim 1, wherein
the request for a consumer polygon further includes a specific transaction criteria, and
the transaction data included in each transaction data entry corresponding to a polygon vertex includes the specific transaction criteria.

9. The method of claim 8, wherein the request for a consumer polygon further includes one or more additional transaction criteria, and the method further comprises:
generating, by the processing device, an additional polygon maps for the consumer related to the specific consumer profile for each of the one or more additional transaction criteria, wherein each of the one or more additional polygon maps includes a plurality of polygon vertices, each polygon vertex being at a geographic location corresponding to a geographic location included in a transaction data entry included in the specific consumer profile where the included transaction data includes the respective additional transaction criteria.

10. The method of claim 8, further comprising:
generating, by the processing device, a plurality of polygon maps for a plurality of consumers; and
aggregating, by the processing device, sets of polygon maps based on at least one of: similarity of polygons, overlap of polygons, common demographics, and common transaction profiles.

11. A system for generating a consumer polygon map, comprising:
a profile database configured to store a plurality of consumer profiles, wherein each consumer profile includes data related to a consumer including at least a consumer identifier and a plurality of transaction data entries, each transaction data entry including data related to a payment transaction involving the related consumer including at least transaction data and a geographic location;
a receiving device configured to receive a request for a consumer polygon, wherein the request for a consumer polygon includes at least a specific consumer identifier; and
a processing device configured to
identify, in the profile database, a specific consumer profile where the included consumer identifier corresponds to the specific consumer identifier, and
generate a polygon map for the consumer related to the specific consumer profile, wherein the polygon map includes a plurality of polygon vertices, each polygon vertex being at a geographic location corresponding to a geographic location included in a transaction data entry included in the specific consumer profile.

12. The system of claim 11, wherein each polygon vertex included in the generated polygon map is within a predetermined geographic distance from each other polygon vertex.

13. The system of claim 11, wherein
each transaction data entry further includes a transaction time and/or date, and
each polygon vertex included in the generated polygon map is associated with the transaction time and/or date included in the corresponding transaction data entry included in the specific consumer profile.

14. The system of claim 13, wherein the generated polygon map includes a plurality of polygon sides, each polygon side connecting at least two polygon vertices, the two polygon vertices including consecutive transaction times and/or dates.

15. The system of claim 11, wherein
each transaction data entry further includes a transaction time and/or date, and
each polygon vertex included in the generated polygon map corresponds to a transaction data entry included in the specific consumer profile including a transaction time and/or date within a predetermined period of time.

16. The system of claim 11, further comprising:
a transmitting device configured to transmit the generated polygon map.

17. The system of claim 11, wherein
the processing device is further configured to analyze the geographic location included in each transaction data entry included in the specific consumer profile to identify a plurality of frequent geographic locations associated with the related consumer, and
the geographic location for each polygon vertex is an identified frequent geographic location.

18. The system of claim 11, wherein
the request for a consumer polygon further includes a specific transaction criteria, and
the transaction data included in each transaction data entry corresponding to a polygon vertex includes the specific transaction criteria.

19. The system of claim 18, wherein
the request for a consumer polygon further includes one or more additional transaction criteria, and
the processing device is further configured to generate an additional polygon maps for the consumer related to the specific consumer profile for each of the one or more additional transaction criteria, wherein each of the one or more additional polygon maps includes a plurality of polygon vertices, each polygon vertex being at a geographic location corresponding to a geographic location included in a transaction data entry included in the specific consumer profile where the included transaction data includes the respective additional transaction criteria.

20. The system of claim 18, wherein the processing device is further configured to
generate a plurality of polygon maps for a plurality of consumers, and
aggregate sets of polygon maps based on at least one of: similarity of polygons, overlap of polygons, common demographics, and common transaction profiles.
